(19) United States
(12) Patent Application Publication
(10) Pub. No.: US 2026/0268548 A1
(43) Pub. Date: Sep. 10, 2026

(54) REAL-TIME MULTI-SOURCE VIDEO PIPELINE

(71) Applicant: CANON U.S.A., INC., MELVILLE, NY (US)

(72) Inventor: Bradley Scott Denney, Irvine, CA (US)

(21) Appl. No.: 18/721,762

(22) PCT Filed: Dec. 21, 2022
(86) PCT No.: PCT/US2022/082180

§ 371 Date: Jun. 19, 2024

Related U.S. Application Data
(60) Provisional application No. 63/292,758, filed on Dec. 22, 2021.

(51) Int. Cl. G06T 11/60; G06T 1/20

(52) U.S. Cl. CPC G06T 11/60; G06T 1/20

(57) ABSTRACT

An image processing apparatus and method according the present disclosure is provided and includes one or more memories storing instructions and one or more processors that, upon executing the instructions, are configured to obtain one or more video sources of video data, specify a layout identifying positions within a frame that the obtained video sources are to be positioned, generate an output video stream based on the specified layout using pixel mappings for a target output frame to be displayed on a display of a computing device, provide the output video stream as an input to one or more buffers, and for every frame of the output video stream exiting the one or more buffers, dynamically render the output video stream frames from the one or more buffer, wherein each frame output in the specified layout.

### CROSS REFERENCE TO RELATED APPLICATIONS

This application claims priority from U.S. Provisional patent Application Ser. No. 63/292,758 filed on Dec. 22, 2021, the entirety of which is incorporated herein by reference.

### BACKGROUND

### Field

The present disclosure relates to image processing and, more specifically, to generating a composite image from a plurality of image sources.

### Description of the Related Art

There are many applications that allow for the rendering of a plurality of different video data streams in a composite layout. One such type of application is a video conference application that receives real-time video from different sources and can be displayed in a single user interface. However, there is a need to improve the speed with which these layouts are compiled and rendered for real-time video processing. A system and method according to the present disclosure remedies these drawbacks.

### SUMMARY

An image processing apparatus and method according the present disclosure is provided and includes one or more memories storing instructions and one or more processors that, upon executing the instructions, are configured to obtain one or more video sources of video data, specify a layout identifying positions within a frame that the obtained video sources are to be positioned, generate one or more pixel mappings for one or more output frame pixel locations the one or more pixel mappings map respective sources of video data to the specified layout, obtain an output frame from one or more stream buffers, and dynamically render one or more of the output frame pixels from the one or more stream buffers via the respective one or more pixel mappings.

In one embodiment, the one or more buffers includes at least a first buffer and a second buffer such that the second buffer is provided with a subsequent frame of the output video stream while a previous frame of the output video stream is being dynamically rendered. In another embodiment, the one or more stream buffers includes at least a first stream buffer and a second stream buffer such that the second stream buffer is provided with a subsequent frame of the output video stream while a previous frame of the output video stream is being dynamically rendered.

In another embodiment, the one or more pixel mappings for one or more output frame pixel locations each comprise one or more pixel locations of one of the video sources of video data. In another embodiment, wherein the one or more pixel locations of one of the video sources of video data comprise a predetermined number of neighboring pixels in the source video. In some instances, the pixel mapping further includes respective weighting information associated with each of the predetermined number of neighboring pixels in the source video.

In another embodiment, the output video stream saves, for each target pixel in a pixel list, a pixel mapping each target pixel back to a pixel in the respective one of the sources of video data. In this embodiment, the pixel mapping may include information mapping each pixel to source pixel and a predetermined number of neighboring pixels adjacent to the source pixel. Additionally, the pixel mapping further includes weighting information associated with each of the predetermined number of neighboring pixels used to interpolate the source pixel to the target pixel.

In another embodiment, the image processing apparatus generates the specified layout which includes a source boundary definition identifying a portion of a video frame to be included as a respective one of the video sources, a target boundary definition describing a location in the image buffer using relative pixel coordinates that the respective one of the video sources is stored, and orientation information identifying an orientation of the respective one of the video sources is viewed in the target frame.

In a further embodiment, the image processing apparatus is configured to calculate source pixel to target pixel transformations using a two dimensional transform that accounts for two dimensional rotation and two dimensional translation from coordinate space for the source pixels to coordinate space for the target pixel.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates an image processing algorithm according to the present disclosure.

FIG. 2 illustrates an image processing algorithm according to the present disclosure.

FIG. 3 illustrates the hardware configuration according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

The present disclosure describes a multi-source video processing pipeline that takes one or more video or image sources and composing them into a video stream according to a provided layout. The system advantageously uses predefined layouts and resolutions for the target output composite image such that these predefined features enable the calculations needed to perform image/video rendering can be largely pre-calculated and the runtime (frame to frame) computation can be minimized to minimize the overhead of the real-time processing. This advantageously reduces the image processing cost and improves the speed that the video data stream is rendered by a computing device.

The present disclosure provides an image processing algorithm that compiles a plurality of image sources (real-time video, still, or combination) into a single output data stream whereby the images, when output and displayed within a user interface on a display device, will be provided in a predetermined layout. The algorithm is embodied as a set of computer executable instructions which configures a processor (CPU) to perform the instruction. The algorithm may reside on any computing device such as a laptop, desktop or server computer so long as the computing device is able to obtain image data from one or more image capturing devices. Exemplary algorithms are described hereinafter.

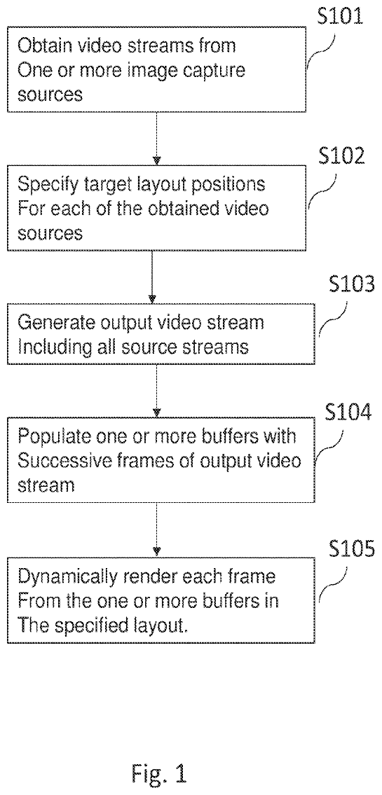

FIG. 1 illustrates an exemplary embodiment of the image processing algorithm for creating an image pipeline to be rendered on a display device. Initially, the algorithm creates a new video pipeline by adding, in S101, one or more image sources as desired to be combined in to a single composite display. The one or more image sources include one dynamic image content and static content. Exemplary types of dynamic content includes, but is not limited to, a video stream and/or images being shared from a screen share function on a computing device such as when a user selects information from a window being displayed on a display device and causes that information to be available to other computing devices. In some embodiments, the video stream includes a live captured video data stream being captured by an image capture device (e.g. camera-still or video). In other embodiments, the video stream may be a pre-recorded video that has been stored in memory for later use. Static content that may be included as one of the image sources in the newly created video pipeline include a still image captured by an image capture device. In one embodiment, the still image is one that will be provided as an overlay image superimposed on top of another type of image source such as a video data stream. In other embodiments, the static content may also include a watermark or other type of static image that includes an alpha channel thereby allowing for alpha blending to be performed and all of the static image to be visible on a display on top of another image source such as a video.

In S102, from the one or more image sources, layout information is specified to identify and process these sources according to a particular layout within the video stream that will ultimately be output for display. The sources may specify a layout which includes one or more of (a) the region in the source image coordinates to be placed into the output (target) video stream, (b) the region in the output (target) video stream where the source is placed, (c) the z-order in the target for the source which identifies which image source is rendered on top of one another, in the case of an overlay being one of the sources; and (d) rotation and flip status to be applied to the source which specifies that the source image be flipped left-to-right (or vice versa) and then rotated before placing/rendering in the target video frame.

In some embodiments the source layout information includes a source rectangle describing the crop rectangle of the source image to be placed into the target frame, a target rectangle describing the location of the rectangle in target image buffer in relative coordinates (from 0.0 to 1.0) to which the source should be placed, and an orientation of the source as it is viewed in the target frame. The source layout can be modified via several functions that will produce new values for the parameters that make up the source layout information. For example the source may undergo the operations including, but not limited to (a) rotate Clockwise 90 degrees; (b) rotate Counter-clockwise 90 degrees; (c) Flip Left-to-Right; (d) Flip Up-to-down; (e) move position by delta x and delta y; (f) resize to fit target frame (fit with borders on top or sides if needed so that full source is shown in target frame at maximal resolution while preserving the source aspect ratio; (g) resize to fill target frame (fill the window with the source while preserving aspect ratio thereby causing top-bottom of source to not be shown or left-right sides to not be shown if target aspect ratio does not match source); (h) resize by percentage preserving aspect ratio; (i) resize to original size centering source in target frame; (j) crop the source according to a new source rectangle (updates the target rectangle appropriately); and (k) uncrop the source.

The Source Layout class also provides mechanisms to calculate the source pixel to target pixel transformations. These transformations are represented as a 2-dimensional transform accounting for 2-D rotation and 2-D translation from one coordinate space to another. The 2-D transform can be parameterized by

$$T = [ \begin{matrix}a & b & {δ}_{x} \\ c & d & {δ}_{y} \\ 0 & 0 & 1\end{matrix} ] = D \cdot S \cdot R \cdot F$$

Where the parameters of the matrix can be computed with the matrices D, S, R, and F, where D is the translation matrix

$$D = [ \begin{matrix}1 & 0 & {δ}_{x} \\ 0 & 1 & {δ}_{y} \\ 0 & 0 & 1\end{matrix} ]$$

S is the scaling matrix

$$S = [ \begin{matrix}α & 0 & 0 \\ 0 & β & 0 \\ 0 & 0 & 1\end{matrix} ]$$

R is the rotation matrix

$$R = [ \begin{matrix}cos θ & - s in θ & 0 \\ sin θ & cos θ & 0 \\ 0 & 0 & 1\end{matrix} ]$$

F is the flip transform (left-to-right)

$$F = \{ \begin{matrix}[ \begin{matrix}1 & 0 & 0 \\ 0 & 1 & 0 \\ 0 & 0 & 1\end{matrix} ] , & if not slipped \\ [ \begin{matrix}- 1 & 0 & 0 \\ 0 & 1 & 0 \\ 0 & 0 & 1\end{matrix} ] , & if flipped\end{matrix}$$

For non-zero scaling parameters, the resulting transformation is invertible and we may conveniently calculate forward and reverse pixel mappings as will be described below.

In S103, the algorithm generates the output video stream including all source streams and compiles the video stream according to the provided layout to precompute pixel mappings for the target video frame. In S103, the compiling of the streams may separate the target pixels into different types of target pixels. A first type of target pixels include pixels made of purely static content which are those pixels from an image source that never change from frame to frame and can be rendered in the target image buffer(s) one time and do not need to be updated for each frame of the video. A second type of target pixels are pixels composed of dynamic content. These pixels may change frame-to-frame and are rendered repeatedly via a render function called for each frame. A third type of target pixel is a combination of dynamic content and static content. The third type of target pixel includes pixels that contain dynamic content (e.g. video) alpha blended with static content (e.g. watermark or overlay images). In certain embodiments, the third type and second type of target pixel are combined together. A fourth type includes pixels of dynamic content alpha blended with one or more pixels of dynamic and/or static content.

The compiled video stream pipeline saves for each target pixel in a list, the pixel mapping for the target pixels back to the source pixel(s). In one embodiment, the mapping includes information to map the nearest neighbor pixel in the appropriate source (the source with highest z-order). In another embodiment, the mapping includes information to map the 4 nearest neighbors and their associated weightings to be used for bilinear interpolation of the source pixels to the target pixel. In another embodiment, the mapping may include information to map additional source pixels and their associated weightings to be used for other interpolation methods (bi-cubic or Lanczos for example).

Now that the video data stream is created with the appropriate source to target mapping information, the buffers are initialized in S104 and receive successive frames of the video data stream that will be output and communicated for a display on a display device. In some embodiment, a plurality of buffers may be used whereby one buffer can be updated while a previously rendered buffer may be read by the consumer of the video. The one or more buffers are initialized using an initialize Buffers function that renders (one time) the pixels associated with static content and may clear (set to constant color) all other pixels not associated with any content.

In S105, the video frames in the one or more buffers are dynamically rendered in the specified layout for display on a display device. In so doing, for every frame of video call the Render function, which renders all dynamic content output pixels. In some embodiments, a second rendering operation is performed to perform a second pass on watermark output pixels that are visible performing an alpha blend of the dynamic content and the watermark pixels. Since the rendering of each output pixel is independent, the rendering of the output pixels in the target frame may be performed via independent threads or GPU cores.

When rendering a target frame, the source image buffers may be acquired such that they are marked in a read-only state. In this way, the input buffers which are dynamic may be locked from being updated while they are being read to ensure all data rendered from a source originates from the same frame. Once reading is complete the buffer is released by the renderer and it's read count (the number of read instances requested) for the buffer is decremented. Information may be simultaneously written into Image Buffers, but the Image Buffer should have a separate buffer for reading and writing. A thread/process requesting read access (for rendering, for example) obtains the most recently updated buffer within ImageBuffer that is not held with a write access. A thread/process requesting write access (for updating frame) obtains any buffer not currently being written or read from.

In an exemplary rendering operation as discussed above with respect to FIG. 1, The 2-D transforms are determined based on the source layouts and the pixel mappings from each target pixel to the appropriate source pixels nearest neighbor(s) can be calculated along with the appropriate weightings for the source pixels when an advanced interpolation mode (such as bilinear) is used. In some embodiments, the 4 nearest source pixels are found for each target pixel along with the corresponding weightings of those pixels that should be used for bilinear interpolation. The source pixel closest to the target pixels inverse transform map is the “nearest neighbor”. This pixel will have the highest weight when performing the weighted average of the four nearest neighbors via bi-linear interpolation.

For example consider a source image (the third source for example) of size 100×100 consisting of 3 byte pixels [R,G,B]. If the four nearest source pixels corresponding to a target pixel of offset 6000 have source buffer offsets of [30, 33, 330, 333] with corresponding weights of [0.1, 0.3, 0.15, 0.45], then the offset of the nearest neighbor source pixel in the source image is 333 because it has the highest weight. Some embodiments save for each target pixel to be rendered, the offset of the target pixel (6000 in the above example), the offsets of the nearest 4 source pixels ([30, 33, 330, 333] in the above example), the weights of the nearest 4 source pixels ([0.1, 0.3, 0.15, 0.45], in the above example), and the source image buffer id (3 in the above example since this is the third source). This improves the speed at which the images are processed for rendering. In other embodiments, the index of the highest weighted pixel is save and the differences to the next row and their respective neighboring pixels is saved. Let [p1,p2,p3,p4] be the indices of the 4 source pixels where p1 is the nearest neighbor pixel and p2 is the adjacent row pixel to p1, p3 is the pixel next to p1 (in the same row as p1), and p4 is the pixel next to p2 (in the same row). Then we may store [p1, dr, dc] where dr=p2-p1, and dc=p3-p1. Furthermore, while the pixel index p1 may be a large number, dr is smaller being at most +/−the size of one row of pixels, and the value of dc is +/−1. In the above example we may save [333 (highest weighted pixel) as 32 bit unsigned integer), −300 (row offset as 16 bit signed integer), −3 (as signed 8 bit integer)] and these values may be used to compactly store and efficiently recover p1,p2,p3, and p4. Furthermore, some embodiments store the weights as unsigned integers (for example 8 bit integers). In this case, 4 bytes may be used to store weightings. Of course 3 bytes may also be used as the weights should sum to 256 and the last weight can be inferred. When one weight is 256, we can modify the pixel mapping to be [p1, p1, x, y] with weights [255, 1, 0, 0] where the values of x and y are not important.

Additional embodiments reorder the list of nearest pixels and weights to ensure that the nearest neighbor (e.g. the source pixel carrying the highest weight) is listed first. For the example above we change the source offsets to [333, 33, 330, 30] and the weights to [0.45. 0.3, 0.15, 0.1] by swapping the first and last entries. In this way, a rendering process can use either bilinear or nearest neighbor interpolation without additional calculation, because the first pixel in the source offset list will always represent the nearest neighbor pixel.

As a result, the rendering loop is thereby optimized for quick source pixel lookups and weighting as discussed below. An exemplary rendering loop for N target pixels using bilinear interpolation is shown below and from it, it is clear that total number of calculations that occur during this pixel rendering loop is minimized and that most computation has been precomputed at pipeline compile time. During this process, for each destination pixel to be updated, a reference to the destination pixel is obtained along with information about the pixel mapping information which maps the source to the target pixel. In getting the pixel mapping information, a pointer to the pixel source image buffer is retrieved and read based on the source information. Source pixel indices and pixel weights [p1,p2,p3,p4] and [w1,w2,w3,w4] are retrieved and, for each channel in a pixel (e.g. for red, green, blue, and alpha channels), the destination channel is set equal to the sum of each respective source pixel index multiplied by its respective pixel weight

In another exemplary rendering loop for N target pixels that uses nearest-neighbor interpolation is shown below. In this embodiment, there are no calculations happening in this pixel rendering loop other than memory indexing. In this embodiment, for each destination pixel to be updated, a reference to the destination pixel is obtained along with the pixel's mapping information. The pointer to the pixel source image buffer is retrieved and read based on the source information and, for each channel in a pixel (e.g. for red, green, blue, and alpha channels), the destination channel is set equal to the source pixel index.

The above two exemplary rendering loops advantageously use the same pre-calculated pixelInfo information. The first approach is more computationally expensive than the second but provides a better quality bi-linear interpolation that requires more render time computation due to the 4 pixel weighted averaging. The second example uses the nearest neighbor pixel which is always the first pixel offset listed. However, either of the first or second examples discussed above provides a distinct advantage over current compilation algorithms due to the reliance on precomputed calculations and mappings from source to target pixels.

The above algorithms are provided as an example. Computation can be further accelerated by treating pixels as multi-byte objects (e.g. 32 bit pixels) and processing the 32 bits simultaneously rather than byte by byte (channel by channel). In some embodiments the above algorithm is embodied using single input/multiple data instructions (SIMD). Further embodiments perform these tasks in parallel via a GPU. An exemplary algorithm causes the 4 source pixels (32-bits each) to be loaded into a 128-bit register (1 byte for each channel) as as uint8's (8-bit unsigned integer)

$$[ [ r 1 , g 1 , b 1 , a 1 ] , [ r 2 , g 2 , b 2 , a 2 ] , [ r 3 , g 3 , b 3 , a 3 ] , [ r 4 , g 4 , b 4 , a 4 ] ]$$

The unsigned bytes are converted into unsigned 16-bit unsigned integers into new 256-bit register as unit16's. A 32-bit weight vector [X,X,X, [w1, w2, w3, w4]] is loaded in into 128-bit register and weights are expanded to 128 bit as follows:

$$[ [ 0 , 0 , 0 , w 1 ] , [ 0 , 0 , 0 , w 2 ] , [ 0 , 0 , 0 , w 3 ] , [ 0 , 0 , 0 , w 4 ] ]$$

Each 32-bit integer holding an 8-bit weight is multiplied by 0x01010101 which expands this to

$$[ [ w 1 , w 1 , w 1 , w 1 ] , [ w 2 , w 2 , w 2 , w 2 ] , [ w 3 , w 3 , w 3 , w 3 ] , [ w 4 , w 4 , w 4 , w 4 ] ]$$

This is further expanded as unit16's and each short is multiplied as follows and the lower 16-bits are kept as

$$[ [ w 1 * r 1 , w 1 * g 1 , w 1 * b 1 , w 1 * a 1 ] , [ w 2 * r 2 , … ] = [ [ wp 1 ] , [ wp 2 ] , [ wp 3 ] , [ wp 4 ] ]$$

Thereafter, we horizontally add 64-bit words (e.g. sum up 4 consecutive 64 bit integers) [[wp1+wp2+wp3+wp4]]. In this example embodiment, the four nearest neighbor pixels are weighted according to the predetermined weighting through a series of specialized 128-bit and 256-bit instructions thereby performing much of the computation simultaneously.

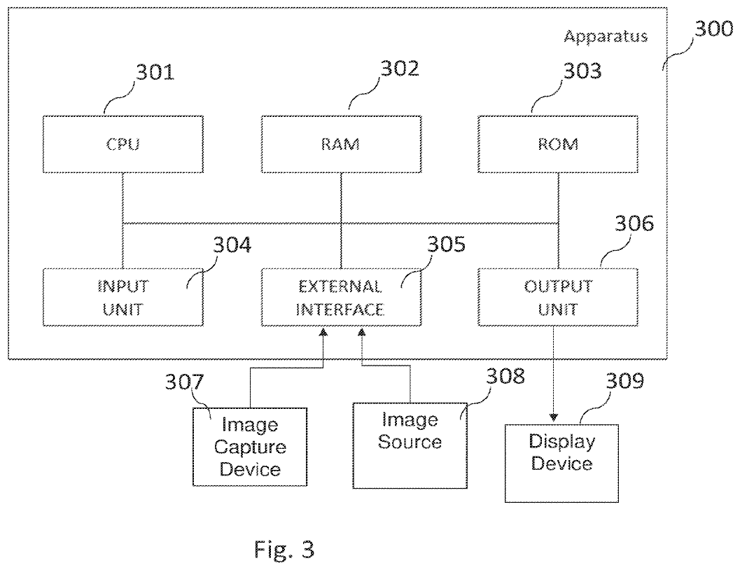

According to another embodiment, the rendering processing performed as described above may be performed according to a list of rendering tasks based on priority with which the render processing must be performed. This is illustrated in FIG. 3 which illustrates a frame rendering pipeline organized by rendering priority and source rendering according to the rendering method being performed. This pipeline breaks the video frame rendering into one or more lists of (sometimes homogeneous) pixel mapping tasks where each pixel mapping task contains the data and operations necessary to render one or more pixels in the target output frame.

As an example, a target output frame pixel may be a linear combination of a plurality of pixels from a source image. The combination or weights of the source pixel that are used may be precomputed for the mapping task. As an example, a target pixel may be the average of the 4 nearest pixels in a source image with equal weighting so that the target pixel's red channel is the average of the corresponding 4 source pixels red channels. In this example the weighting of each target pixel is 1/4. However, in general the weightings may vary and be unequal, but generally the weightings sum to 1. Similarly the weighting is applied to the green, blue, and sometimes alpha channels of the four source pixels. The result is the following

$$r\_target = ( r 1 + r 2 + r 3 + r 4 ) / 4$$

$$g\_target = ( g 1 + g 2 + g 3 + g 4 ) / 4$$

$$b\_target = ( b 1 + b 2 + b 3 + b 4 ) / 4$$

$$α\_taget = ( α 1 + α 2 + α 3 + α 4 ) / 4$$

According to this framework, bi-linear interpolation may be accomplished by appropriately choosing the weightings for each pixel mapping. All target pixels originating from the same source and that follow the same mapping technique (e.g. a nearest neighbor mapping, a bilinear mapping, a bicubic mapping, a mapping implemented through parallel execution, etc.) may be placed in a mapping task list. And collections of mapping tasks list may be organized such that a system comprising of parallel processors, and processors capable of executing vectorized data processing may efficiently perform the video rendering task. Tasks of the same priority are generally formed to be independent tasks and not dependent on each other, however, they may be dependent on tasks of a higher priority. Since the tasks of the same priority are independent of each other (e.g. each operating and modifying independent output pixels), these tasks can be distributed across computation CPU or GPU cores. For example if a processor has 4 cores, 4 tasks can be executed simultaneously since they are all modifying a different destination pixel (a different memory location).

Additionally, when rendering pixels in the target output frame, some pixels may combine pixels from multiple sources. For example, one or more target pixels may be composed through the alpha blending of a plurality or source pixels and these source pixels may include the weighting of the source pixels according to some interpolation scheme. In these cases, it is sometimes advantageous to render the pixel in steps, starting with the source with the lowest z-order and then rendering the partially transparent sources “on top” of the lower z-order pixels according to the specified z-order or the sources. In this case, we can provide a mechanism for the system to render all lower z-order portions of the pixel first before rendering the semi-transparent pixels on top of the previous rendering.

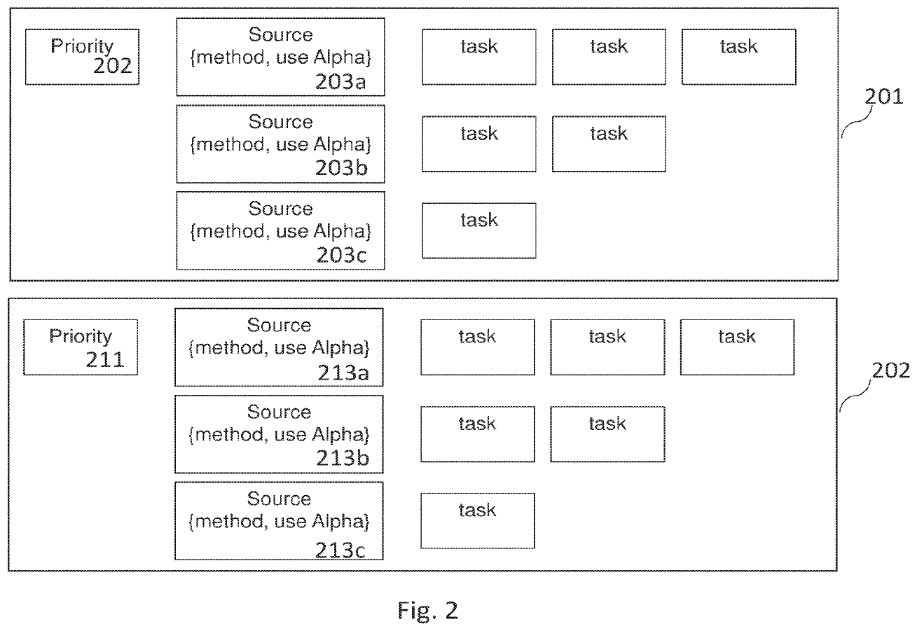

This is shown in FIG. 2 whereby a first list 201 is shown having a first priority level 202 associated therewith. As shown in this example, this rendering task list includes images from sources 203a, 203b, 203c each being rendered according to the same rendering method. Images from source 203a have three rendering tasks associated therewith, whereas images from source 203b and 203c have two and one rendering tasks associated therewith. FIG. 2 also shows a second list 210 having a second priority level 211 associated therewith. As shown in this example, this rendering task list 210 includes images from sources 213a, 213b, 213c each being rendered according to the same rendering method. Images from source 213a have three rendering tasks associated therewith, whereas images from source 213b and 213c have two and one rendering tasks associated therewith. In the above task allocation structure, homogeneous (by method) mapping tasks are organized according to priority and input source. Frame rendering occurs starts with highest priority rendering. By defining rendering priority, the system ensures that all higher priority rendering is performed before the next highest priority rendering is performed. This allows for the rendering of content with some degree of transparency (specified by the pixel's alpha channel) to be rendered and blended to the result obtained via higher priority rendering. For each source based task list for the selected priority (can be done in parallel since these are independent from all other pixel mapping tasks), the source to target mapping method is determined along with whether the determined mapping method is using the sources alpha channel to blend with previously rendered content. Pixel rendering is executed according to the use of alpha blending and the mapping method such that the pixel rendering can be done in parallel since each task is responsible for independent target pixel mappings, for example, via threaded or parallel processing such as a GPU. In other embodiments, the pixel rendering may also use vectorized processing to process the Red, Green, Blue, and Alpha channels in parallel. Or it may process a plurality of pixels in one operation via vectorized processing. This process of parsing and processing the various tasks lists shown in FIG. 2 is repeated until there are no longer any lower priority lists. At that time, the rendering stops.

With respect to the various rendering tasks that may be associated with the particular source video, there are several different embodiments implementing these tasks. In one embodiment, the rendering task may be nearest neighbor interpolation where the task contains a source pixel offset to the nearest source pixel mapping.

In another embodiment, the rendering task may be bilinear interpolation whereby the task contains the four nearest neighbor offsets in the source image and a least 3 weights of the first 3 nearest neighbors (the 4th weight is implicit as the weights typically sum to a fixed number so that all pixels are composed of a constant total weighting). The weights may be specified as floating point numbers or integer numbers. In one embodiment the weight is given as a number between 0 and 256 and the total sum of the weights is 256. Additionally some embodiments store the pixel with the highest weight first so that a first weight of 256 can be stored as 0 since the first weight can never be zero if all weights sum to 256 and the first weight is the maximum of the weights. Thus 4 weights may be stored in memory as 32 bits (8 bits per weight and 4 weights). In other embodiments the 4 weights are stored as 4 16-bit short integers. In still other embodiments the weights are provided in 16-bit short integers between 0 and 256 for each of the up to four channels of the corresponding 4 nearest neighbor pixels in the source image. Thus the weights are given as 16 16-bit integers:

$$w = [ w 0 , w 0 , w 0 , w 0 , w 1 , w 1 , w 1 , w 1 , w 2 , w 2 , w 2 , w 2 , w 3 , w 3 , w 3 , w 3 ]$$

for a total of 256-bits. While the storage of the weights in this manner is not memory efficient, some embodiments use this structure to optimize the real-time processing of the pixels as will be explained further below.

In some configurations the processor in the mapping device may support single instruction multiple data operations. For example some processors support 256-bit operations. One such embodiment loads the 4 source pixels into a 256-bit register such that each pixel channel is stored as a 16-bit word of the form

$$p = [ r 0 , g 0 , b 0 , a 0 , r 1 , g 1 , b 1 , a 1 , r 2 , g 2 , b 2 , a 2 , r 3 , g 3 , b 3 , a 3 ] = [ q 0 , q 1 , q 2 , q 3 ]$$

where qi is the 64 bit concatenation of each pixel channel as 16-bits for the i-th pixel. The multiplication of p with w for each 16 bit unit generates

$$p * w = [ w 0 * i 0 , w 0 * g 0 , w 0 * b 0 , w 0 * a 0 , w 1 * r 1 , … ]$$

In this embodiment since the maximum of any weight is 256 or 0x100 (in hexadecimal), and each pixel channel value is from 0 to 255 (0x00 to 0xff in hexadecimal), the result of the multiplication will not overflow the 16 bit boundaries. Computing p*w and summing the elements as 64-bit unsigned integers the following is determined

$$x = sum\_ 64 ( p * w ) = [ w 0 * i 0 + w 1 * r 1 + w 2 * r 2 + w 3 * r 3 , w 0 * g 0 + w 1 * g 1 + w 2 * g 2 + w 3 * g 3 , … ]$$

This summing of 64-bit unsigned integers effectively performs 4 sums of 16-bit unsigned integers since the total weighting of the pixels does not exceed 256 and each pixel channel value does not exceed 255. Thus there is no possibility for the addition to carry over 16-bit boundaries. The above sum will contain the final pixel channel values shifted by 8 bits (multiplied by 256 total weight). So selecting the 1^{st}, 3^{rd}, 5^{th}, and 7^{th} byte of the 64-bit unsigned integer x will return the target r,g,b,a channels in 8-bit units. By processing the pixel channels simultaneously using large (256-bit in this case) CPU registers, the computation can be done more efficiently than through standard programming methods.

In another embodiment, the rendering task includes a bicubic interpolation which calculates additional source pixels and weights. For example, bicubic interpolation may store the locations of the 16 nearest source pixels and 16 weights in order to estimate the destination pixel value via bicubic interpolation. The source pixel offsets and weights may be precomputed in a similar fashion to how the bilinear pixel offsets and weights were computed ahead of time.

In another embodiment the rendering task includes alpha blending (nearest neighbor, bilinear, or bicubic). When a source specifies that alpha blending is used the task firsts calculates the interpolated pixel and then uses the alpha channel to alpha blend the pixel with the existing pixel value that was rendered at a higher priority.

Other rendering tasks include pixel picture adjustments which are applied once a pixel value is calculated. Such adjustments may modify brightness, contrast, saturation, and hue. These adjustments are typically made via pixel look up tables or real-time calculations of the resulting pixel value given its current intermediate value. These adjustments have no memory requirements for each mapping but typically do require the storage of a universally used pixel look up table or pixel value transform parameters. Pixel adjustments are typically done at the lowest priority so that all prerequisite pixel value calculations are already done before the pixel adjustments are made.

Another rendering task is a static content rendering whereby, sometimes, the rendered pixels are generated from static content like a background image for example. In the case where target frame pixels only rely on static content (e.g. inputs that do not change from frame to frame), these pixels may be rendered in an output buffer only once. These pixels do not need to be updated every frame. However, if picture adjustments are applied, then the mapping of the static input according to new picture settings must be updated. Thus, the rendering task may also query output frames (according to internal frame flags) to determine whether the frames' static content is up to date. If not the rendering task will update the static content if the frame is marked as dirty or “out of date”. For this to work properly, the processing pipelines must tell the output frames when to mark their internal buffers as dirty so that the rendering process will be able to determine if the static content needs to be redrawn for any given frame. This is performed by providing expiration information associated with respective static image information to ensure what is ultimately being rendered is proper given the time and image source.

FIG. 3 illustrates exemplary hardware that represents an apparatus 300 that performs the above image processing algorithm and that can be used in implementing the above described disclosure. The apparatus includes a CPU 301, a RAM 302, a ROM 303, an input unit 304, an external interface 305, and an output unit 306. The CPU 301 controls the apparatus 300 by using a computer program (one or more series of stored instructions executable by the CPU) and data stored in the RAM 302 or ROM 303. Here, the apparatus may include one or more dedicated hardware or a graphics processing unit (GPU), which is different from the CPU 301, and the GPU or the dedicated hardware may perform a part of the processes by the CPU 301. As an example of the dedicated hardware, there are an application specific integrated circuit (ASIC), a field-programmable gate array (FPGA), and a digital signal processor (DSP), and the like. The RAM 302 temporarily stores the computer program or data read from the ROM, data supplied from outside via the external interface 305, and the like. In the application described herein, the external interface 305 receives information in the form of image data from a plurality of image sources. In one embodiment, an image capture device 307 captures image data according to particular image capture area and provides the captured images to the apparatus 300 via the external interface 305. The image capture device 307 is described generically but it is understood that the image capture device is a camera that is configured to capture real-time video images (and sound) or still images, or both. In another embodiment, an image source 308 is provided and the apparatus 300 via the external interface 305 may obtain pre-recorded image data from the image source 308. For example, the image source may be an external storage having pre-recorded image data stored thereon. In another example, the image source 308 may be output from a particular application executing on an external apparatus such as another computer where the user of the computer has selected a window or user interface being displayed on their computer for sharing to another user. The external interface 305 communicates with external device such as PC, smartphone, camera and the like. The ROM 303 stores the computer program and data which do not need to be modified and which can control the base operation of the apparatus. The input unit 304 is composed of, for example, a joystick, a jog dial, a touch panel, a keyboard, a mouse, or the like, and receives user's operation, and inputs various instructions to the CPU 301. The communication with the external devices may be performed by wire using a local area network (LAN) cable, a serial digital interface (SDI) cable, WIFI connection or the like, or may be performed wirelessly via an antenna. The output unit 306 is composed of, for example, a display unit that causes display of information to be provided to a display device 309 and displays a graphical user interface (GUI) thereon and. The output unit 306 also includes a sound output unit such as a speaker. The output unit 306 may also contain a network connection whereby generated video streams from the video processing embodiments described in FIG. 1 and FIG. 2 are transmitted to a remote system.

The scope of the present disclosure includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. An image processing apparatus comprising
one or more memories storing instructions;
one or more processors that, upon executing the instructions, are configured to:
obtain one or more video sources of video data;
specify a layout identifying positions within a frame that the obtained video sources are to be positioned;
generate one or more pixel mappings for one or more output frame pixel locations the one or more pixel mappings map respective sources of video data to the specified layout;
obtain an output frame from one or more stream buffers;
dynamically render one or more of the output frame pixels from the one or more stream buffers via the respective one or more pixel mappings.

2. The image processing apparatus according to claim 1, wherein the one or more stream buffers includes at least a first stream buffer and a second stream buffer such that the second stream buffer is provided with a subsequent frame of the output video stream while a previous frame of the output video stream is being dynamically rendered.

3. The image processing apparatus according to claim 1, wherein the one or more pixel mappings for one or more output frame pixel locations each comprise one or more pixel locations of one of the video sources of video data.

4. The image processing apparatus according to claim 3, wherein the one or more pixel locations of one of the video sources of video data comprise a predetermined number of neighboring pixels in the source video.

5. The image processing apparatus according to claim 4, wherein the pixel mapping further includes respective weighting information associated with each of the predetermined number of neighboring pixels in the source video.

6. The image processing apparatus according to claim 1, wherein the specified layout includes
a source boundary definition identifying a portion of a video frame to be included as a respective one of the video sources;
a target boundary definition describing a location in the image buffer using relative pixel coordinates that the respective one of the video sources is stored; and
orientation information identifying an orientation of the respective one of the video sources is viewed in the target frame.

7. The image processing apparatus according to claim 1, wherein execution of the instructions further configures the one or more processors to
calculate source pixel to target pixel transformations using a two dimensional transform that accounts for two dimensional rotation and two dimensional translation from coordinate space for the source pixels to coordinate space for the target pixel.

8. An image processing method comprising
obtaining one or more video sources of video data;
specifying a layout identifying positions within a frame that the obtained video sources are to be positioned;
generating one or more pixel mappings for one or more output frame pixel locations the one or more pixel mappings map respective sources of video data to the specified layout;
obtaining an output frame from one or more stream buffers;
dynamically render one or more of the output frame pixels from the one or more stream buffers via the respective one or more pixel mappings.

9. The image processing method according to claim 8, wherein the one or more stream buffers includes at least a first stream buffer and a second stream buffer such that the second stream buffer is provided with a subsequent frame of the output video stream while a previous frame of the output video stream is being dynamically rendered.

10. The image processing method according to claim 8, wherein the one or more pixel mappings for one or more output frame pixel locations each comprise one or more pixel locations of one of the video sources of video data.

11. The image processing method according to claim 10, wherein the one or more pixel locations of one of the video sources of video data comprise a predetermined number of neighboring pixels in the source video.

12. The image processing method according to claim 11, wherein the pixel mapping further includes respective weighting information associated with each of the predetermined number of neighboring pixels in the source video.

13. The image processing method according to claim 8, wherein the specified layout includes
a source boundary definition identifying a portion of a video frame to be included as a respective one of the video sources;
a target boundary definition describing a location in the image buffer using relative pixel coordinates that the respective one of the video sources is stored; and
orientation information identifying an orientation of the respective one of the video sources is viewed in the target frame.

14. The image processing apparatus according to claim 8, wherein execution of the instructions further configures the one or more processors to
calculate source pixel to target pixel transformations using a two dimensional transform that accounts for two dimensional rotation and two dimensional translation from coordinate space for the source pixels to coordinate space for the target pixel.
